(19) United States
(12) Patent Application Publication
(10) Pub. No.: US 2026/0067876 A1
(43) Pub. Date: Mar. 5, 2026

(54) METHODS FOR MEASUREMENT-LESS BEAM INDICATION WITH MULTI-BAND ANTENNA MODULES

(71) Applicant: QUALCOMM Incorporated, San Diego, CA (US)

(72) Inventors: Vasanthan RAGHAVAN, West Windsor Township, NJ (US); Yan ZHOU, San Diego, CA (US)

(21) Appl. No.: 18/817,125

(22) Filed: Aug. 27, 2024

(51) Int. Cl. H04W 72/0453; H04W 16/28; H04W 72/044

(52) U.S. Cl. CPC H04W 72/0453; H04W 16/28; H04W 72/046

(57) ABSTRACT

In an aspect of the disclosure, a method, a computer-readable medium, and an apparatus are provided. The apparatus may comprise at least one memory; and at least one processor coupled to the at least one memory and, based at least in part on information stored in the at least one memory, the at least one processor, individually or in any combination, is configured to: transmit beam correspondence information between a first set of beams and a second set of beams, wherein the first set of beams includes one or more beams associated with a first frequency band and the second set of beams includes one or more beams associated with a second frequency band; and receive a configuration for measurement of one or more beam measurements using the first frequency band.

### TECHNICAL FIELD

The present disclosure relates generally to communication systems, and more particularly, to systems and methods for measurement-less beam indication and management using multiband antenna modules.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may comprise at least one memory; and at least one processor coupled to the at least one memory and, based at least in part on information stored in the at least one memory, the at least one processor, individually or in any combination, is configured to: transmit beam correspondence information between a first set of beams and a second set of beams, wherein the first set of beams includes one or more beams associated with a first frequency band and the second set of beams includes one or more beams associated with a second frequency band; and receive a configuration for measurement of one or more beam measurements using the first frequency band.

In an aspect of the disclosure, a method, a computer-readable medium, and an apparatus are provided. The apparatus may comprise at least one memory; and at least one processor coupled to the at least one memory and, based at least in part on information stored in the at least one memory, the at least one processor, individually or in any combination, is configured to: receive beam correspondence information between a first set of beams and a second set of beams, wherein the first set of beams includes one or more beams associated with a first frequency band and the second set of beams includes one or more beams associated with a second frequency band; and provide a configuration for measurement of one or more beam measurements using the first frequency band.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 illustrates an example of communication between a UE and a base station that is based on beams.

FIG. 5 is a diagram illustrating example multi-band modules, in accordance with various aspects of the present disclosure.

FIG. 6 is a diagram illustrating a wireless communication process with measurement-less beam indication and management using multiband antenna modules, in accordance with various aspects of the present disclosure.

FIGS. 7A-7D are diagrams illustrating example mappings between beams in different frequency bands on the multi-band modules, in accordance with various aspects of the present disclosure.

FIG. 8 is a call diagram illustrating a wireless communication process.

FIG. 9A and FIG. 9B are flowcharts of methods of wireless communication.

FIG. 10A and FIG. 10B are flowcharts of methods of wireless communication.

FIG. 11 is a diagram illustrating an example of a hardware implementation for an example apparatus and/or UE.

FIG. 12 is a diagram illustrating an example of a hardware implementation for an example network entity.

### DETAILED DESCRIPTION

Various aspects of the present disclosure relate generally to wireless communication, and more specifically to systems and methods for measurement-less beam indication and management using multiband antenna modules. In some aspects, a user equipment (UE) may support measurement-less beam management aspects across multiple frequency bands based on a beam correspondence. For example, based on a beam correspondence, a UE may use beam information (e.g., beam measurements) for beams associated with antenna elements for a first frequency band to manage and/or determine beams associated with antenna elements for a second frequency band. This enables the UE to perform beam management for the second frequency band without measurements of signals in the second frequency band, for example. In some aspects, the UE may indicate support for this capability to a network node. The UE may transmit beam correspondence information for beams associated with these frequency bands to the network node. The UE may communicate with the network node via one or more beams of the first frequency band, based on measurements performed on those beams. Using the beam correspondence information, the network node may determine one or more beams of the second frequency band that the UE may use for communication, without requiring the UE to measure the beams of the second frequency band. The network node may then configure the UE to communicate via the identified beam on the second frequency band, for example, through radio resource control (RRC) or other signaling.

Particular aspects of the subject matter described in this disclosure can be implemented to achieve one or more of the following advantages. For example, by considering a mapping between beam coverage areas (e.g., beamwidths or peak coverage regions) across different frequency bands, the described techniques can simplify beam management, reduce the need for extensive measurements across different frequency bands, and improve communication efficiency in multi-band wireless communication systems. The aspects presented herein can improve efficient use of wireless resources by enabling the UE to perform beam management associated with the second frequency band without, or with a reduction in, transmitting signals for measurement in the second frequency band. Furthermore, the aspects presented herein can increase battery power savings at the UE by reducing the measurement of such signals in the second frequency band at the UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

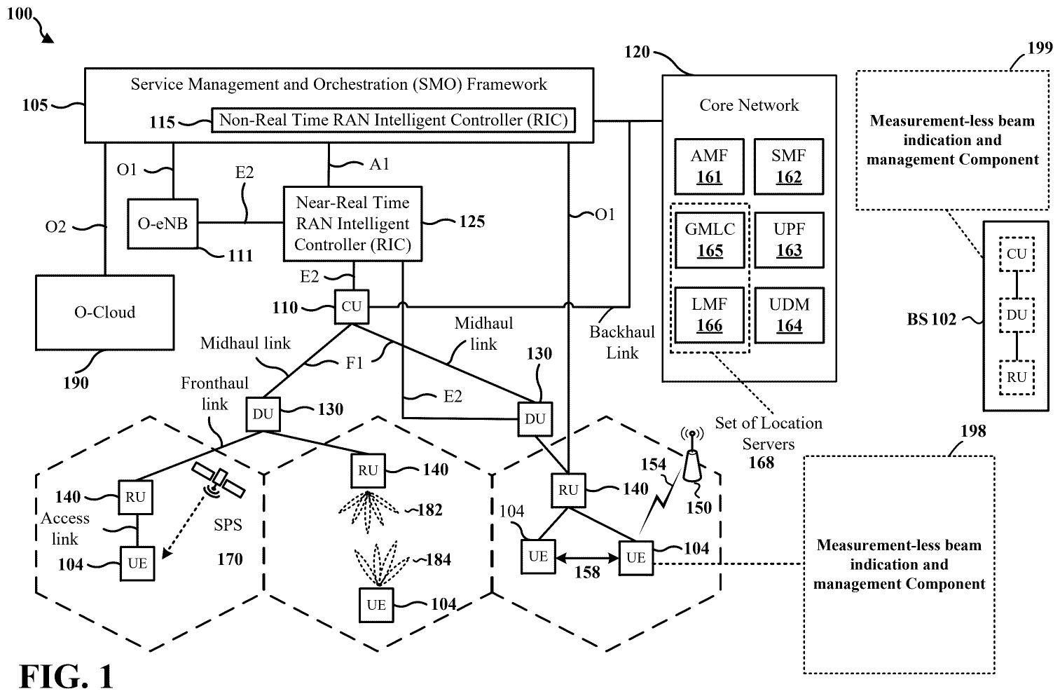

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to perform the measurement-less beam indication and management. In certain aspects, the base station 102 may have a component 199 that may be configured to perform the measurement-less beam indication and management.

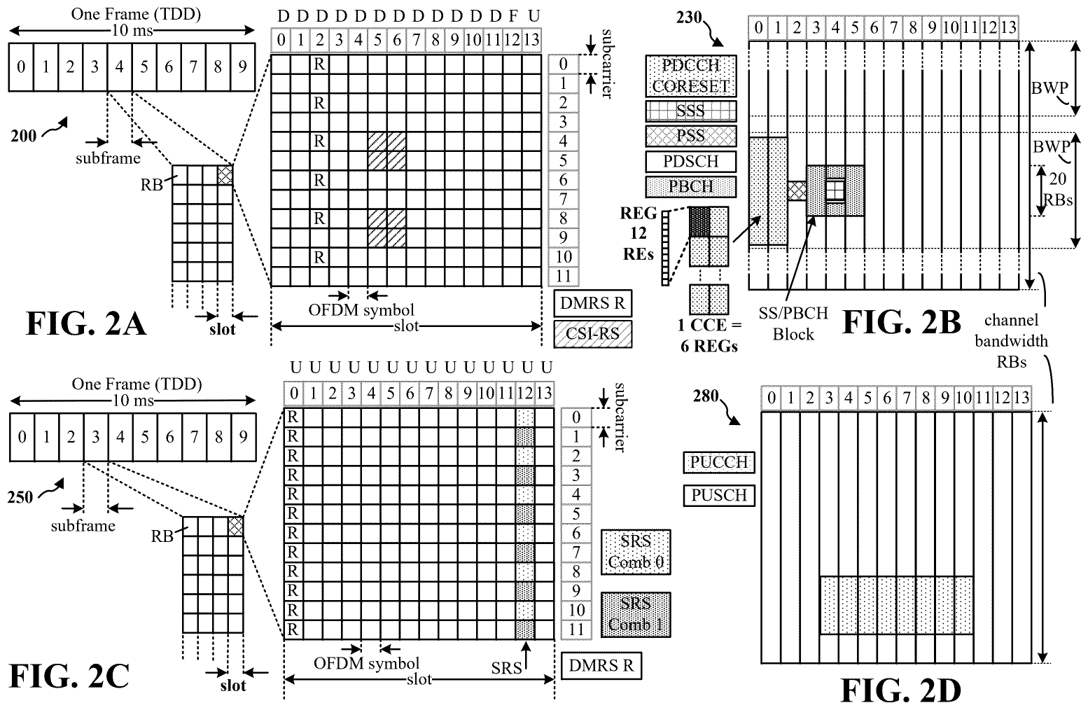

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

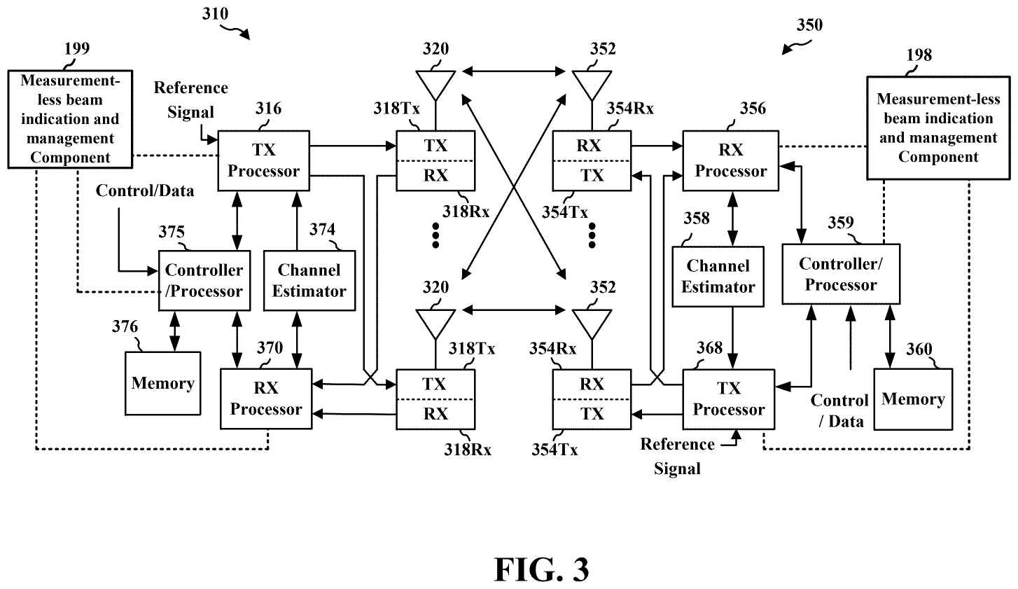

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement-less beam indication and management component 198 of FIG. 1, such as transmitting beam correspondence information for a first set of one or more beams associated with a first frequency band and a second set of one or more beams associated with a second frequency band; receiving a configuration for measurement of one or more beam measurements using the first frequency band; transmitting an indication of support for a capability associated with measurement-less beam correspondence across the first frequency band and the second frequency band; receiving a RRC configuration indicating one or more of a first component carrier (CC) or a first beam group identifier (ID) corresponding to a first analog beam group and a second CC or a second beam group ID corresponding to a second analog beam group; receiving control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration; receiving a RRC configuration indicating a first set of transmission configuration indicator (TCI) states for a first analog beam group associated with the first frequency band and a second set of TCI states for a second analog beam group associated with the second frequency band; receiving a medium access control-control element (MAC-CE) indicating a mapping between one or more TCI states of the first set of TCI states for the first frequency band and one or more TCI states of the second set of TCI states for the second frequency band; identifying a first beam associated with the first frequency band based on the one or more beam measurements in the first frequency band; and communicating using a second beam for the second frequency band based on a measurement-less association with the first beam associated with the first frequency band.

At least one of the TX processor 316, the RX processor 370, and the controller/processor 375 may be configured to perform aspects in connection with the measurement-less beam indication and management component 199 of FIG. 1, such as receiving beam correspondence information for a first set of one or more beams associated with a first frequency band and a second set of one or more beams associated with a second frequency band; providing a configuration for measurement of one or more beam measurements using the first frequency band; receiving an indication of support for a capability associated with measurement-less beam correspondence across the first frequency band and the second frequency band; configuring a RRC configuration indicating one or more of a first CC or a first beam group ID corresponding to a first analog beam group for the first frequency band and a second CC or a second beam group ID corresponding to a second analog beam group for the second frequency band; providing control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration; configuring a radio resource control (RRC) configuration indicating a first set of transmission configuration indicator (TCI) states for a first analog beam group associated with the first frequency band and a second set of TCI states for a second analog beam group associated with the second frequency band; providing a medium access control-control element (MAC-CE) indicating a mapping between one or more TCI states of the first set of TCI states for the first frequency band and one or more TCI states of the second set of TCI states for the second frequency band.

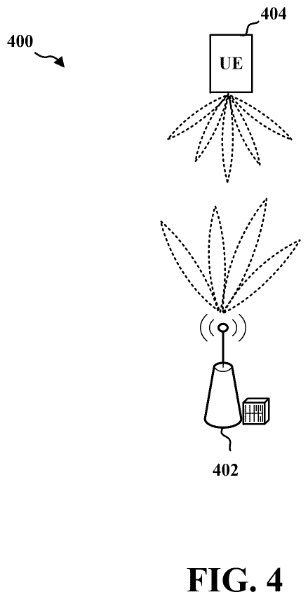

FIG. 4 illustrates an example of communication between a UE and a network node, such as a base station, that is based on beams, e.g., which may be referred to as directional beams, or beamformed signals, among other examples. The base station 402 and the UE 404 may each include a plurality of antennas, e.g., antenna elements, antenna panels, and/or antenna arrays, to facilitate beamforming. The base station 402 may transmit a beamformed signal to the UE 404 in one or more transmit directions. The UE 404 may receive the beamformed signal from the base station 402 in one or more receive directions. The UE 404 may also transmit a beamformed signal to the base station 402 in one or more transmit directions. The base station 402 may receive the beamformed signal from the UE 404 in one or more receive directions. The base station 402 and UE 404 may perform beam measurements, beam training, and/or beam management to determine the best receive and transmit directions for communication.

As an example, the UE 404 and/or base station 402 may perform various aspects of beam management, e.g., including a P1, P2, and P3 procedure using SSB or CSI-RS measurements; a U1, U2, and U3 procedure using SRS transmissions and measurement, L1-RSRP reporting. P1 may be referred to as a beam selection, P2 may be referred to as a beam refinement for the transmitter (e.g., base station 402), and P3 may be referred to as a beam refinement for a receiver (e.g., a UE). For P1, the base station 402 may sweep transmissions over a set of beams. The UE 404 performs measurements for the set of beams and reports one or more beams having the best measurements from the set of beams. The P1 beam sweep may be performed with wider beams than P2 and P3, in some aspects. At P2, the base station 402 transmits a signal on a set of narrower beams over a narrower range, and the UE 404 reports one or more beams to the base station 402 from the set of narrower beams. At P3, the base station 402 may transmit using a fixed beam (e.g., rather than the beams sweeps performed in P1 and P2), e.g., transmitting repeatedly using the same beam. The UE 404 can then perform measurements in a beam sweep pattern to determine a receive beam, e.g., a spatial filter on a receiver antenna array.

Wireless communication systems may use higher frequency bands such as FR2 (24.25 GHz-52.6 GHz) and beyond. For example, 5G New Radio (NR) technology may use higher frequency bands such as FR2 (24.25 GHz-52.6 GHz) and beyond. The higher frequency bands may assist with achieving ultra-high data rates and low latency, e.g., for advanced applications, including augmented reality (AR), virtual reality (VR), and/or autonomous driving. However, the use of these frequency bands can present significant challenges, particularly in the design and implementation of antenna modules in UE.

For example, the integration of multiple antenna modules, each supporting different frequency bands, may be challenging due to the limited physical space available in modern UEs. As the UEs become more compact, the demand for efficient use of space increases.

Incorporating separate antenna modules for each frequency band may not only consume the physical space but also increases the cost, complexity and power consumption of/at the UE.

Additionally, supporting multiple frequency bands may complicate beam management at the UE and/or base station, e.g., to perform separate/independent beamforming processes for each frequency band, leading to increased computational complexity and additional signaling and coordination between the UE and the network.

To address these challenges, the aspects disclosed herein provide a novel approach utilizing multi-band antenna modules, capable of operating across multiple frequency bands (e.g., FR2-1, FR2-2, and FR3) within the same UE, where the antenna modules for the multiple frequency bands are co-located or closely located. The aspects presented herein introduce methods for cross-band beam correspondence, enabling measurements on one frequency band, with the associated information used for determining beamforming parameters for other frequency bands. As a result, practicing the disclosed aspects may reduce signaling and measurements across frequency bands, simplify beam management, and/or enhance the overall efficiency of the communication system.

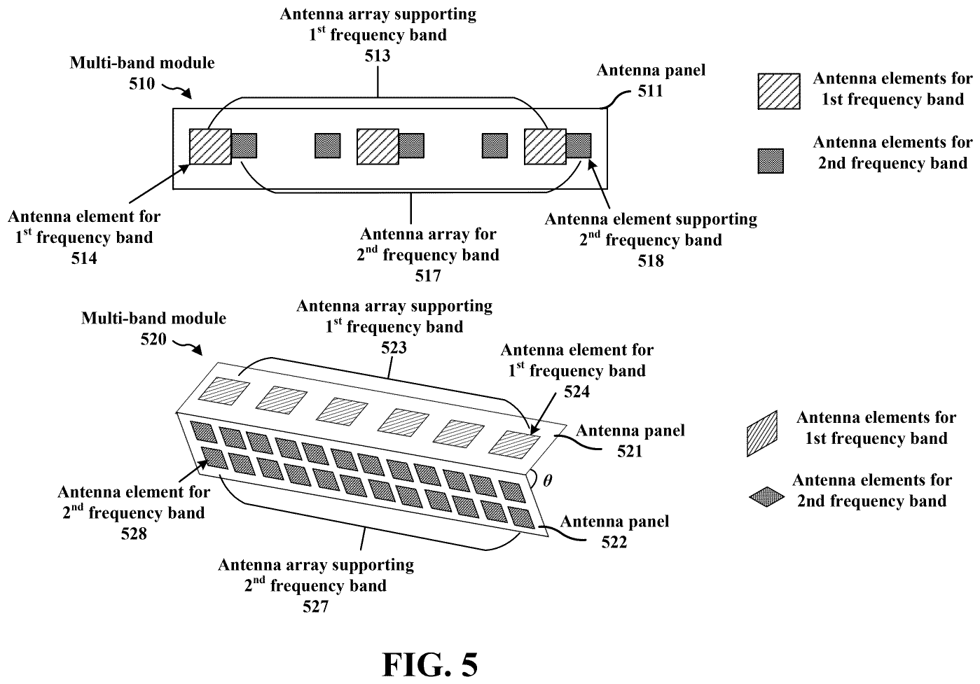

For example, FIG. 5 is a diagram illustrating example multi-band antenna modules, in accordance with various aspects of the present disclosure. It is understood that the number of frequency bands, the number of antenna modules/arrays, the number of antenna element in the antenna array, etc., are provided for illustrative purposes. The concepts presented herein may be applied for antenna modules having any number of antenna elements or arrays, depending on desired performance.

As noted above, a UE (e.g., corresponding to the UE 104 in FIG. 1, the UE 350 in FIG. 3, and/or the UE 404 in FIG. 4) may include one or more multi-band modules, such as multi-band module 510 and/or 520, that include antenna modules/arrays for different frequency bands or ranges. In some aspects, the antenna arrays supporting different frequency bands may be co-located on the same antenna panel, e.g., which may be referred to as a single antenna panel or shared antenna panel. For example, as illustrated in FIG. 5, the multi-band module 510 may include an antenna array 513 supporting a first frequency band, which comprises a first number of antenna elements. To illustrate the concept, FIG. 5 shows the antenna array 513 having three antenna elements 514 (e.g., a 1×3 array of antenna elements). The multi-band module 510 may also include an antenna array 517 supporting a second frequency band, which comprises a second number of antenna elements. To illustrate the concept, FIG. 5 shows the antenna array 517 having five antenna elements 518 (e.g., a 1×5 array). In some aspects, the two arrays of antenna elements may have an equal number of antenna elements (e.g., each having a 1×3 array, as an example). As well, the concepts presented herein are not limited to a 1×3 array or antenna elements or a 1×5 array of antenna elements, and may be applied for antenna arrays having any number of antenna elements. The antenna arrays 513 and 517 may be co-located on the same antenna panel 511 of the multi-band module 510, and the boresight directions of the corresponding antenna elements in antenna arrays 513 and 517 may be similar (e.g., pointing in approximately the same direction(s)).

Additionally, or alternatively, in some aspects, the antenna arrays supporting different frequency bands may be positioned closely but located on different antenna panels of the antenna module. For example, as illustrated in FIG. 5, the multi-band module 520 may include an antenna array 523 supporting a first frequency band, which comprises six antenna elements 524 (e.g., a 1×6 array of antenna elements). The multi-band module 520 may also include an antenna array 527 supporting a second frequency band, which comprises 24 antenna elements 528 (e.g., a 2×12 array of antenna elements). The antenna arrays 523 and 527 may be positioned on antenna panels 521 and 522 of the multi-band module 520, respectively. In some aspects, antenna panels 521 and 522 may form an angle of approximately 85° to 90° (e.g., θ∈[85°, 90°]). As a result, the boresight directions of the corresponding antenna elements in antenna arrays 523 and 527 may be distinct, as discussed herein.

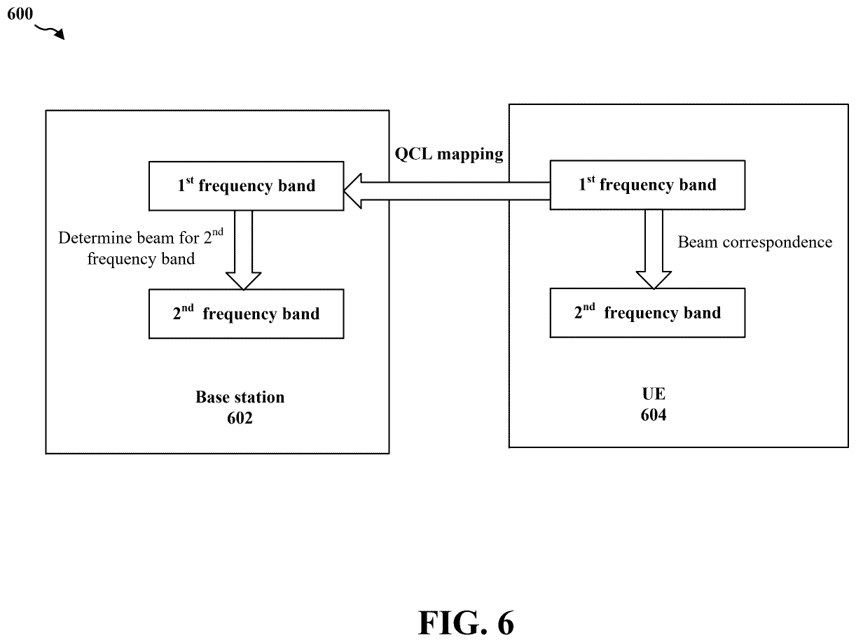

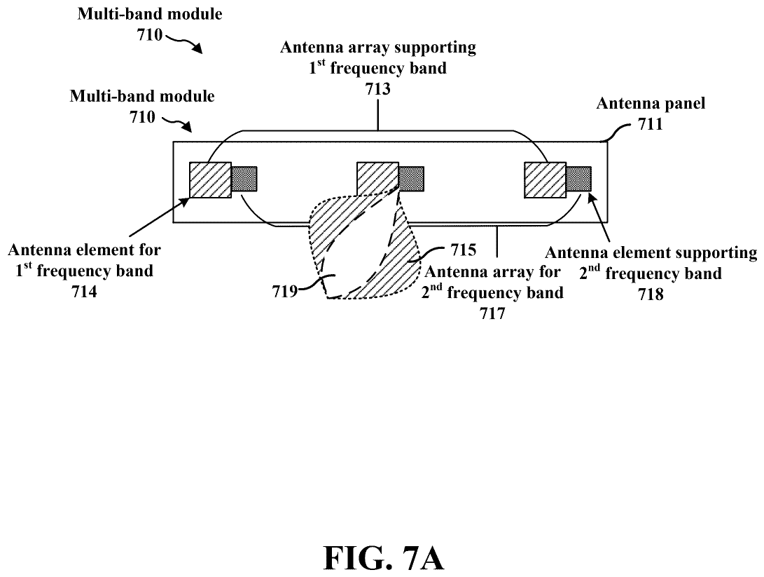

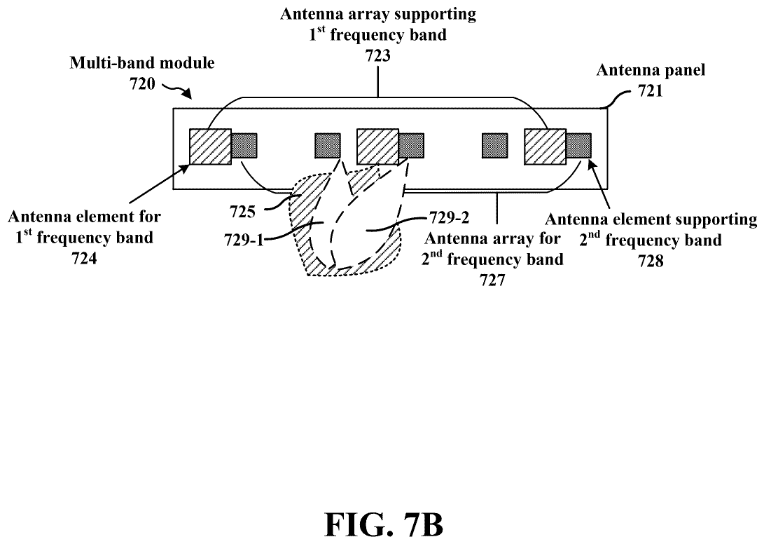

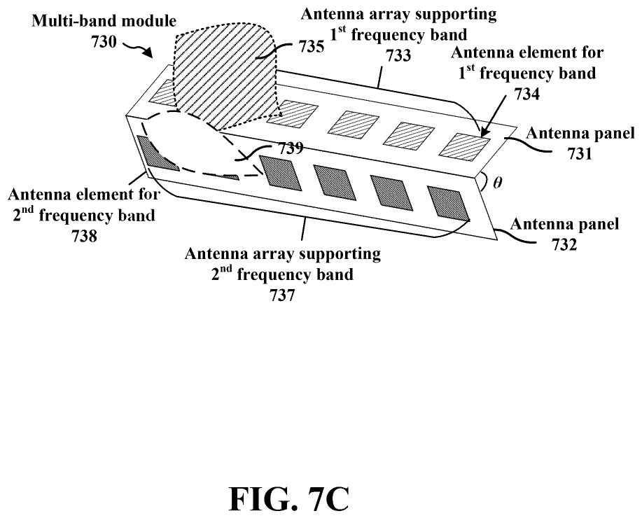

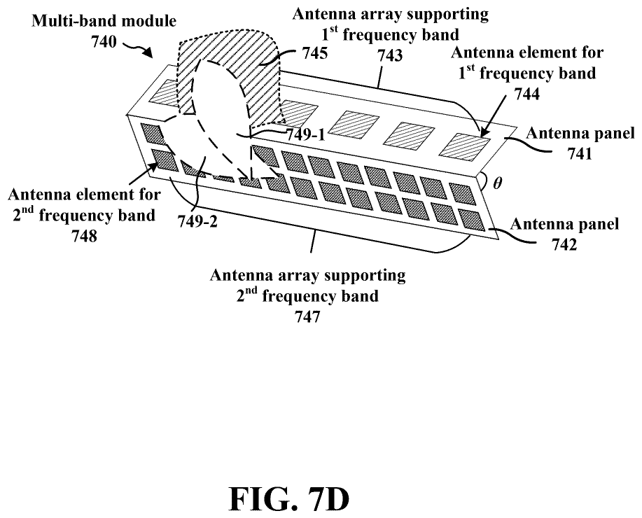

Aspects presented herein may involve leveraging cross-band beam correspondence information to reduce measurements and/or signaling across one or more frequency bands. For example, FIG. 6 is a diagram illustrating aspects of a wireless communication process 600 (referred to as “process 600” hereinafter) with measurement-less beam indication and management using multiband antenna modules, in accordance with various aspects of the present disclosure. The multiband antenna modules may include aspects described in connection with any of FIG. 5 or FIGS. 7A-7D, for example. The process 600 may be performed between a network node, such as one or more components of a base station 602, and a UE 604. In some aspects, the base station 602 may correspond to the base station 102 in FIG. 1. The aspects performed by the base station 602 may be performed either by a base station in aggregation or by one or more components of a bases station (e.g., a CU 110, a DU 130, and/or an RU 140). Similarly, aspects performed by the base station 602 may be performed by the base station 310 in FIG. 3, either as a whole or to one or more components of the base station 310. The UE 604 may correspond to the UE 104 in FIG. 1, the UE 350 in FIG. 3, and/or the UE 404 in FIG. 4. It is understood that although the example in FIG. 6 illustrates the concept for two frequency bands (e.g., the first and the second frequency bands) are shown in the flow diagram, the concept may be applied for more than two frequency bands, in some aspects.

As shown in FIG. 6, the UE 604 may support a capability associated with measurement-less beam correspondence across the first frequency band and the second frequency band (e.g., utilizing multi-band module 510 and/or 520 in FIG. 5). The UE 604 may have, know, or obtain beam correspondence information that indicates a correspondence between beams for the first frequency band and beams for the second frequency band. For example, the beam correspondence may be based on a one-to-one mapping between beams for the different frequency bands, e.g., as illustrated in FIG. 7A, or a one-to-multiple beam mapping between a first set of beams (or beam indices) for the first frequency band and a second set of beams (or beam indices) for the second frequency band, e.g., as illustrated in FIG. 7B. Additionally, or alternatively, the beam correspondence may be based on a deterministic mapping of steered beam directions between a first set of beams for the first frequency band and a second set of beams for the second frequency band, e.g., as described in connection with FIGS. 7C and 7D.

FIGS. 7A-7D are diagrams illustrating example mappings between beams for different frequency bands on multi-band modules, in accordance with various aspects of the present disclosure. It is understood that the number of frequency bands, the number of antenna modules/arrays, the number of antenna element in the antenna array, etc., are provided for illustrative purposes. Any suitable number may be applied, depending on desired performance.

As shown in FIG. 7A, the multi-band module 710 may include an antenna array 713 supporting a first frequency band, which comprises three antenna elements 714. The multi-band module 710 may also include an antenna array 717 supporting a second frequency band, which also comprises three antenna elements 718 (e.g., the same number of antenna elements 718 as the antenna elements 714 in the first antenna array 713). The antenna arrays 713 and 717 may be positioned on antenna panel 711. The antenna elements 714 may form beams 715 (e.g., one beam 715 is shown), and the antenna elements 718 may form beams 719 (e.g., one beam 719 is shown). The boresight directions of the corresponding antenna elements in antenna arrays 713 and 717 may be similar (e.g., the corresponding beam 715 and beam 719 may point in approximately the same direction). Because the number of antenna elements 714 in antenna array 713 and the number of antenna elements 718 in antenna array 717 are the same, a one-to-one mapping may be established between a first set of beam indices for the first frequency band (e.g., beams 715) and a second set of beam indices for the second frequency band (e.g., beams 719). For example, one beam 715 of the first frequency band may be mapped to one corresponding beam 719 of the second frequency band.

As shown in FIG. 7B, the multi-band module 720 may include an antenna array 723 supporting a first frequency band, which comprises three antenna elements 724. The multi-band module 720 may also include an antenna array 727 supporting a second frequency band, which comprises five antenna elements 728 (e.g., a different number of antenna elements 728 compared to the antenna elements 724 in the first antenna array 723). The antenna arrays 723 and 727 may be positioned on antenna panel 721. The antenna elements 724 may form beams 725 (beam 725 is shown to illustrate the concept), and the antenna elements 728 may form beams (beams 729-1 and 729-2 are shown to illustrate the concept). The boresight directions of the beams formed by the corresponding antenna elements in antenna arrays 723 and 727 may be similar (e.g., beam 725 and beams 729-1 and 729-2 may point in approximately the same direction). Because the number of antenna elements 724 in antenna array 723 and the number of antenna elements 728 in antenna array 727 are different, a one-to-multiple beam mapping may be established between a first set of beam indices for the first frequency band (e.g., beams 725) and a second set of beam indices for the second frequency band (e.g., beams 729-1 and 729-2). For example, one beam 725 of the first frequency band may be mapped to more than one corresponding beam of the second frequency band (e.g., beams 729-1 and 729-2 may correspond to two antenna elements 728).

As noted above, in some aspects, antenna arrays supporting different frequency bands may be positioned closely but located on different antenna panels of an antenna module. For example, as shown in FIG. 7C, the multi-band module 730 may include an antenna array 733 supporting a first frequency band, which comprises six antenna elements 734. The multi-band module 730 may also include an antenna array 737 supporting a second frequency band, which also comprises six antenna elements 738 (e.g., the same number of antenna elements 738 as the antenna elements 734 in the first antenna array 733). The antenna arrays 733 and 737 may be positioned on antenna panels 731 and 732 of the multi-band module 730, respectively. In some aspects, antenna panels 731 and 732 may form an angle (e.g., θ). In some aspects, the angle may be approximately 85° to 90° (e.g., θ∈[85°, 90°]).

The antenna elements 734 may form beams 735 (beam 735 is shown to illustrate the concept), and the antenna elements 738 may form beams 739 (beam 739 is shown to illustrate the concept). While the boresight directions of the beams formed by the corresponding antenna elements in antenna arrays 733 and 737 may be distinct, they can be deterministically related and may be derived based on the spatial relationship between the antenna panels 731 and 732 (e.g., the angle θ formed by antenna panels 731 and 732), particularly when the coverage of one or more beams from beams 735 overlaps with the coverage of one or more beams from beams 739. Therefore, when the beam coverages overlap, the beam correspondence between beams 735 and beams 739 may be based on a deterministic mapping of steered beam directions between the first set of beams for the first frequency band (e.g., beams 735) and the second set of beams for the second frequency band (e.g., beams 739).

Additionally, because the number of antenna elements 734 in antenna array 733 and the number of antenna elements 738 in antenna array 737 are the same, a one-to-one deterministic mapping of steered beam directions may be established between the first set of beams for the first frequency band (e.g., beams 735) and the second set of beams for the second frequency band (e.g., beams 739). For example, one beam 735 of the first frequency band may be mapped to one corresponding beam 739 of the second frequency band based on the spatial relationship.

As a further example, as shown in FIG. 7D, the multi-band module 740 may include an antenna array 743 supporting a first frequency band, which comprises six antenna elements 744. The multi-band module 740 may also include an antenna array 747 supporting a second frequency band, which also comprises 24 antenna elements 748 (e.g., a different number of antenna elements 748 compared to the antenna elements 744 in the first antenna array 743). The antenna arrays 743 and 747 may be positioned on antenna panels 741 and 742 of the multi-band module 740, respectively. In some aspects, antenna panels 741 and 742 may form an angle of approximately 85° to 90° (e.g., θ∈[85°, 90°]).

The antenna elements 744 may form beams 745 (e.g., one beam 745 is shown), and the antenna elements 748 may form beams (e.g., two beams 749-1 and 749-2 are shown). While the boresight directions of the corresponding antenna elements in antenna arrays 743 and 747 may be distinct, they can be deterministically related and may be derived based on the spatial relationship between the antenna panels 741 and 742 (e.g., the angle θ formed by antenna panels 741 and 742), particularly when the coverage of one or more beams from beams 745 overlaps with the coverage of one or more beams from beams 749-1 and 749-2. Therefore, when the beam coverages overlap, the beam correspondence between beams 745 and beams 749-1 and 749-2 may be based on a deterministic mapping of steered beam directions between the first set of beams for the first frequency band (e.g., beams 745) and the second set of beams for the second frequency band (e.g., beams 749-1 and 749-2).

Additionally, because the number of antenna elements 744 in antenna array 743 and the number of antenna elements 748 in antenna array 747 are the different, a one-to-multiple deterministic mapping of steered beam directions may be established between the first set of beams for the first frequency band (e.g., beams 745) and the second set of beams for the second frequency band (e.g., beams 749-1 and 749-2). For example, one beam 745 of the first frequency band may be mapped to more than one corresponding beam of the second frequency band (e.g., beams 749-1 and 749-2 may correspond to two antenna elements 748) based on the spatial relationship.

Referring back to FIG. 6, the UE 604 may provide information to the base station 602 regarding beam correspondence including a quasi co-location (QCL) relationship (e.g., a QCL mapping) between one or more beams for one frequency band (e.g., the first frequency band) that have a relationship to one or more beams for the second frequency band. The base station 602 may then use the beam correspondence information to determine a measurement-less association between beams associated with the first frequency band and beams associated with a second frequency band (e.g., a cross-frequency QCL relationship between the first set of one or more beams and the second set of one or more beams). The base station 602 may then communicate with the UE 604 (e.g., transmit or receive) based on the received information. For example, the base station may determine a beam to use for communication with the UE in the second frequency band based on information associated with a corresponding beam for the first frequency band. Similarly, the base station may transmit signals in the first frequency band that enable the UE to perform the measurement-less beam management for the second frequency band. In some aspects, the base station may communicate this measurement-less association to the UE 604, allowing the UE 604 to identify and use the appropriate beam(s) in the second frequency band without needing to measure those beams directly.

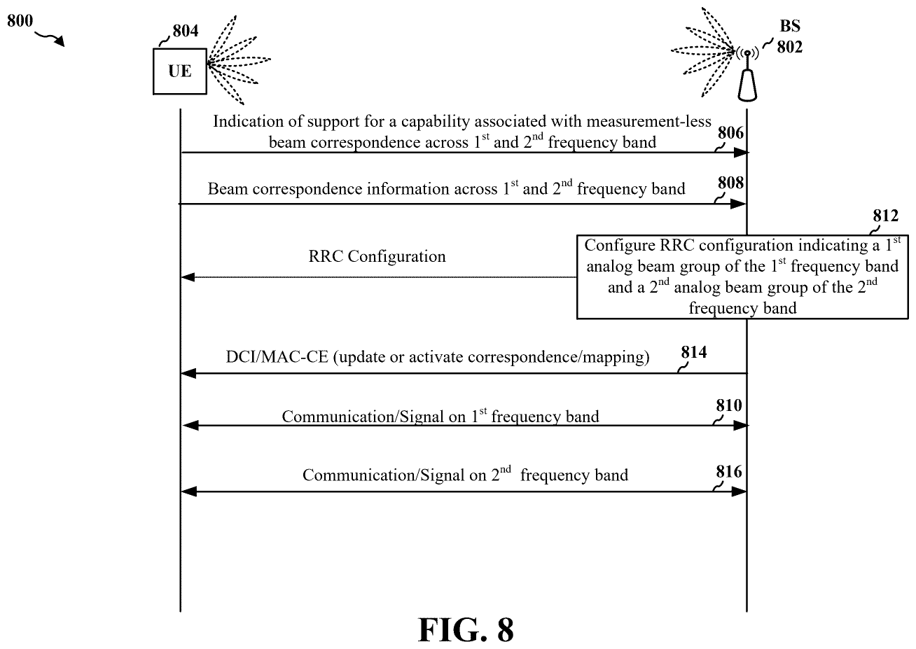

FIG. 8 is a call diagram illustrating a wireless communication process 800, in accordance with various aspects of the present disclosure. The wireless communication process (referred to as “process 800” hereinafter) may be performed between a base station 802 and a UE 804. In some aspects, the base station 802 may correspond to the base station 102 in aggregation and/or by one or more components (e.g., such as a CU 110, a DU 130, and/or an RU 140) in FIG. 1, the base station 310 in aggregation and/or by one or more components in FIG. 3, and the base station 602 in FIG. 6. The UE 804 may correspond to the UE 104 in FIG. 1, the UE 350 in FIG. 3, the UE 404 in FIG. 4, and/or UE 604 in FIG. 6.

As shown at 806, the UE 804 may transmit an indication of support for a capability associated with measurement-less beam correspondence across a first frequency band and a second frequency band to the base station 802. For example, as noted above, the UE 804 may include one or more of the multi-band modules discussed in FIGS. 5 and/or 7A-7D, which support communication on more than one frequency band, including the first frequency band and the second frequency band. In some aspects, this capability may include independent beam management for the first frequency band and the second frequency band.

At 808, the UE 804 may transmit beam correspondence information between a first set of beams and a second set of beams, wherein the first set of beams includes one or more beams associated with the first frequency band and the second set of beams includes one or more beams associated with the second frequency band to the base station 802. In some aspects, this beam correspondence information may indicate a cross-frequency quasi co-location (QCL) relationship between the first set of one or more beams and the second set of one or more beams.

As noted above, the beam correspondence information may be based on a one-to-one mapping between a first set of beam indices for the first frequency band and a second set of beam indices for the second frequency band, as discussed with respect to FIG. 7A and/or 7C. This one-to-one mapping may be applied when the number of antenna elements for the first frequency band in the first antenna array and the number of antenna elements for the second frequency band in the second antenna array are the same.

Additionally, or alternatively, the beam correspondence information may be based on a one-to-multiple beam mapping between a first set of beam indices for the first frequency band and a second set of beam indices for the second frequency band, as discussed with respect to FIG. 7B and/or 7D. This one-to-multiple mapping may be applied when the number of antenna elements for the first frequency band in the first antenna array differs from the number of antenna elements for the second frequency band in the second antenna array.

Additionally, or alternatively, the beam correspondence information may be based on a deterministic mapping of steered beam directions between a first set of beams for the first frequency band and a second set of beams for the second frequency band, as discussed with respect to FIG. 7C and/or 7D. This deterministic mapping may be applicable when the coverage (e.g., beamwidth) of one or more beams associated with the first frequency band overlaps with the coverage of one or more beams associated with the second frequency band, and where the boresight directions of the corresponding antenna elements in the first antenna arrays for the first frequency band and the second antenna arrays for the second frequency band are deterministically related. These relationships may be derived based on the spatial arrangement of the antenna panels where the first and second antenna arrays are located (e.g., the angle θ formed by the antenna panels).

At 810, communication, or exchange of signals, based on the first frequency band may be performed. For example, the UE 804 may receive one or more configurations from the base station 802 for the UE to measure one or more beams using the first frequency band. In some aspects, the base station 802 may transmit one or more signals (e.g., SSB, reference signals such as CSI-RS, among other examples) over the one or more beams (e.g., in a beam sweep manner). The UE 804 performs beam measurements on the received signals, e.g., according to the configuration received from the base station. Based on such configurations, the UE 804 may identify one or more beams associated with the first frequency band for communicating with the base station 802, according to the one or more beam measurements in the first frequency band. In some aspects, the indication of support for a capability associated with measurement-less beam correspondence across the first frequency band and the second frequency band at 806 and beam correspondence information for a first set of one or more beams associated with the first frequency band and the second set of one or more beams associated with the second frequency band at 808 may also be transmitted based on the identified one or more beams associated with the first frequency band. For example, the communication or signals on the first frequency band may be received before the indications 806 and/or 808, in some aspects.

The base station 802 may determine a measurement-less association between beams for the second frequency band and beams associated with the first frequency band based on the indication of support for a capability associated with measurement-less beam correspondence across the first frequency band and the second frequency band at 806 and beam correspondence information for a first set of one or more beams associated with the first frequency band and the second set of one or more beams associated with the second frequency band at 808. In some aspects, the measurement-less association may include the cross-frequency QCL relationship between the first set of one or more beams associated with the first frequency band and the second set of one or more beams associated with the second frequency band. For beam indications across the two bands with independent beam management, the base station 802 can indicate a downlink or uplink beam used on one frequency band (e.g., which may be referred to as FRx) with a downlink or uplink reference signal transmitted on the other frequency band (e.g., which may be referred to as FRy). In some aspects, FR may refer to a frequency range, a frequency, a frequency band, or an analog beamformer used over that frequency range. Thus, the base station may indicate a downlink or uplink beam for a first frequency range, a first frequency, a first frequency band, or a first analog beamformer, based on a downlink or uplink reference signal of a second frequency range, a second frequency, a second frequency band, or a second analog beamformer.

The base station 802 may transmit one or more control messages (e.g., control signaling) indicating an update or an activation of a correspondence between the first analog beam group for the first frequency band and the second analog beam group for the second frequency band. The cross-group beam indication may be based on a dynamic indication, in some aspects. For example, the base station may transmit an RRC configuration (e.g., at 812) to the UE that configures separate CC lists (with CC IDs) or beam group IDs corresponding to different beam groups. Then, the base station may transmit a DCI (e.g., a TCI updating DCI) or a MAC-CE (e.g., a TCI activating a MAC-CE) (e.g., at 814) that indicates applicable beam groups that are updated or activated with reference to the previously RRC configured CC list ID or beam group ID for the indicated or activated TCI state.

For example, in some aspects, aspects of the measurement-less association may be indicated in, or based on, a Radio Resource Control (RRC) configuration 812. For example, the RRC configuration may indicate one or more of a first component carrier (CC) or a first beam group identifier (ID) corresponding to a first analog beam group, and a second CC or a second beam group ID corresponding to a second analog beam group. The base station 802 may then transmit control signaling to the UE 804, indicating an update or activation of a correspondence between the first analog beam group for the first frequency band and the second analog beam group for the second frequency band, based on the first CC and the second CC from the RRC configuration or the first beam group ID and the second beam group ID from the RRC configuration. In some aspects, transmitting the control signaling may involve transmitting a Medium Access Control-Control Element (MAC-CE) and/or Downlink Control Information (DCI).

In some aspects, the cross-group beam indication may be based on a semi-static indication. As an example, the base station may transmit an RRC configuration (e.g., at 812) that indicates that the TCI states indicated for beam group 1 will be applied to beam group 2 as a cross-group beam indication. Then, the base station may transmit a MAC-CE (e.g., at 814) to the UE that updates the mapping (e.g., indicating that the beam group 1 indication is applied to beam group 2).

As an example, the RRC configuration 812 may indicate a first set of Transmission Configuration Indicator (TCI) states for a first analog beam group associated with the first frequency band and a second set of TCI states for a second analog beam group associated with the second frequency band. The base station 802 may then transmit a MAC-CE to the UE 804, indicating a mapping between one or more TCI states of the first set of TCI states for the first frequency band and one or more TCI states of the second set of TCI states for the second frequency band.

At 816, the UE 804 may proceed with communication with the base station 802 based on the second frequency band. For example, the UE 804 may identify and use the appropriate beam(s) in the second frequency band without the need for direct measurement of those beams, relying on the measurement-less association and configuration provided by the base station 802. For example, the UE may measure a signal, or receive communication, on the first frequency band at 810, and may use the measurement or the communication to identify a beam to use for communication on the second frequency band, at 816.

In some aspects, the appropriate beam(s) in the second frequency band may be identified based on one or more of the following criteria: a difference between the first direction of a first beam pattern peak of the first beam associated with the first frequency band and a second direction of a second beam pattern peak of the second beam associated with the second frequency band, an overlap between the first beamwidth of the first beam associated with the first frequency band and the second beamwidth of the second beam associated with the second frequency band, a defined correlation between the first beam and the second beam, a common quasi co-location (QCL) source shared by the first beam and the second beam, a reference signal received power (RSRP) difference between the first beam and the second beam, or an equivalent isotropic radiated power (EIRP) difference between the first beam and the second beam.

For example, the UE 804 may use an FRx beam closest to the FRy beam for receiving or transmitting a RS, in some aspects. One or more of various options may be used as criteria to determine a closest beam. In some aspects, the criteria may be defined, e.g., defined or specified in a wireless standard and known by the UE and network. In some aspects, the criteria may be configured by the base station 802 and/or may be selected autonomously by the UE 804.

In some aspects, the closest beam (or the beam selected for the second frequency) may be identified based on a peak direction of the beam in FRx having a smallest gap to a peak direction of the beam in FRy indicated by the downlink or uplink reference signal transmitted on (or received on) FRy.

In some aspects, the closest beam (or the beam selected for the second frequency) may be identified based on a threshold, such as 3 dB (or X dB) beamwidth of beam in FRx having a highest overlap region with the 3 (or X) dB beamwidth of the beam in FRy indicated by the DL or UL RS transmitted on FRy. As an example, a threshold value, e.g., X, can be configured by the base station based on a UE recommendation.

In some aspects, the closest beam (or the beam selected for the second frequency) may be identified based on a correlation across a sphere of a beam in FRx being highest with the beam in FRy indicated by the downlink or uplink RS transmitted on FRy. In some aspects, the correlation may be defined, e.g., in a wireless standard.

For example, for the same QCL source RS such as an SSB, a delta RSRP between the two UE reception beams on FRx and FRy may be less than X dB in different UE orientations in DL, and the delta EIRP between the two UE transmission beams on FRx and FRy may be less than Y dB in UL. The parameters X and/or Y may be configured by the base station.

The aspects disclosed herein (e.g., establishing QCL relationship and/or beam correspondence) are not limited to cross-frequency bands. A person skilled in the art should appreciate that the same principles may also be applied to establishing relationships for beams between different frequencies, different frequency bands, and/or different analog beamformers.

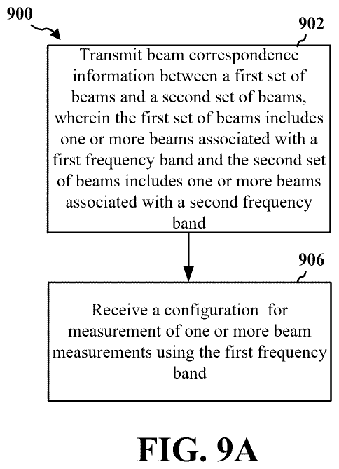

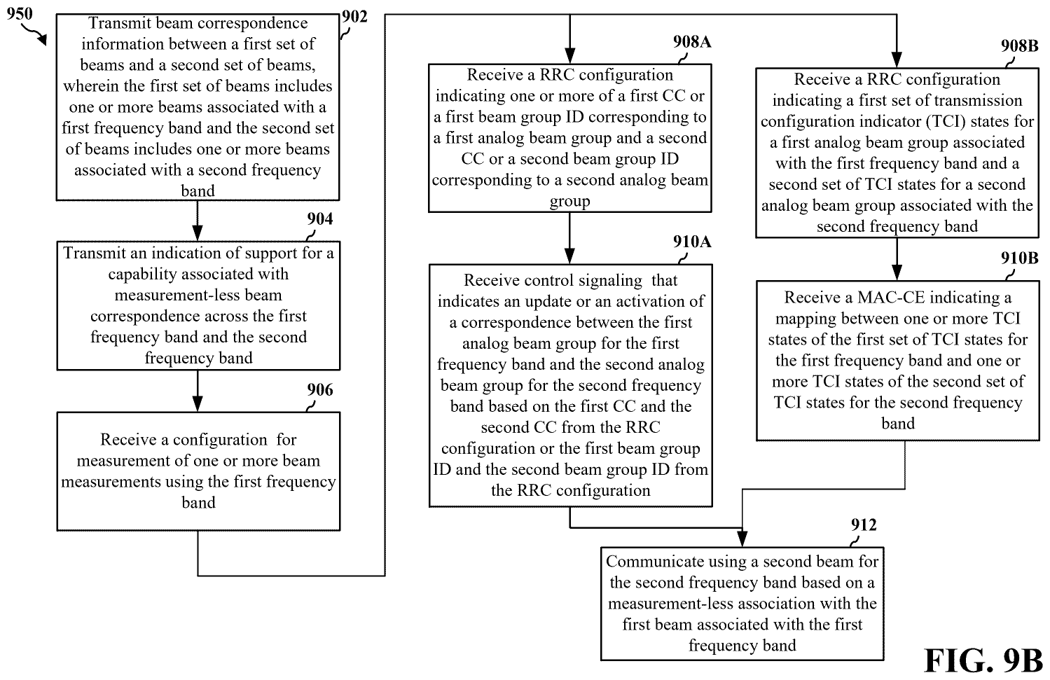

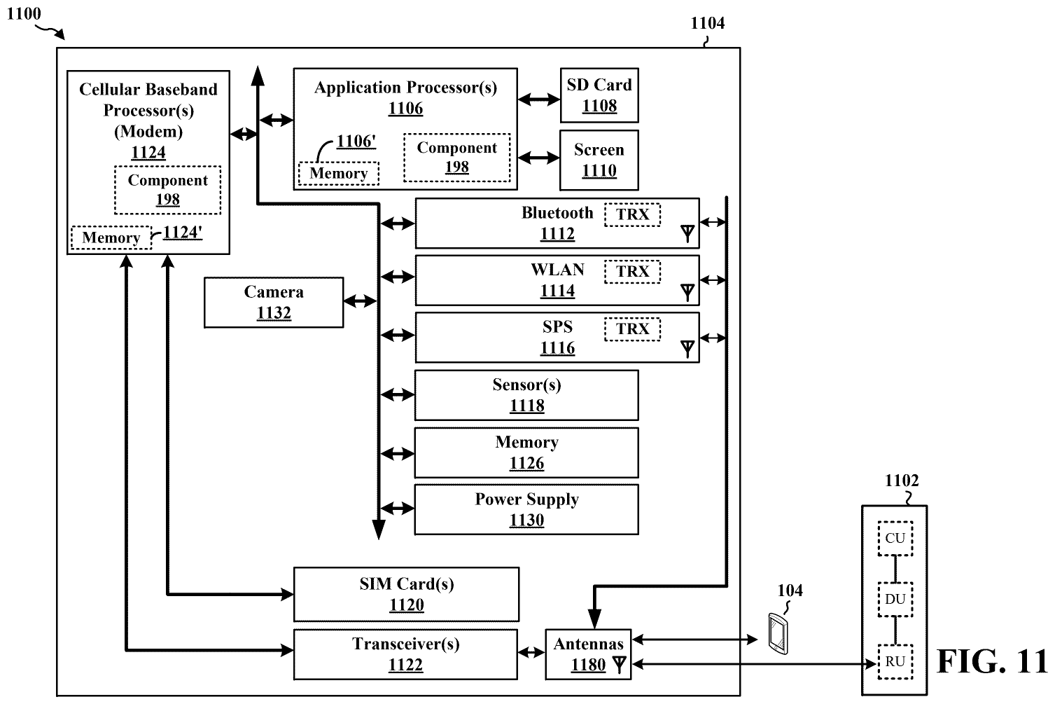

FIG. 9A is a flowchart 900 of a method of wireless communication. The method may be performed by a UE (e.g., the UE 104; the UE 350 in FIG. 3; the UE 404 in FIG. 4; the UE 604 in FIG. 6; the UE 804 in FIG. 8; and/or the apparatus 1104 in the hardware implementation of FIG. 11). The method improves the efficient use of wireless resources and/or reduces power consumption at the UE by enabling measurement-less beam management based on cross-frequency or cross-analog beamforming relationships. Aspects enables additional frequency capability while saving time, power, and signaling measurements for beam management in the additional frequency range.

At 902, the UE may transmit to a base station beam correspondence information between a first set of beams and a second set of beams, wherein the first set of beams includes one or more beams associated with a first frequency band and the second set of beams includes one or more beams associated with a second frequency band. As noted above, the beam correspondence information may be based on a one-to-one mapping between a first set of beam indices for the first frequency band and a second set of beam indices for the second frequency band, as discussed with respect to FIG. 7A and/or 7C. This one-to-one mapping may be applied when the number of antenna elements for the first frequency band in the first antenna array and the number of antenna elements for the second frequency band in the second antenna array are the same.

Additionally, or alternatively, the beam correspondence information may be based on a one-to-multiple beam mapping between a first set of beam indices for the first frequency band and a second set of beam indices for the second frequency band, as discussed with respect to FIG. 7B and/or 7D. This one-to-multiple mapping may be applied when the number of antenna elements for the first frequency band in the first antenna array differs from the number of antenna elements for the second frequency band in the second antenna array.

Additionally, or alternatively, the beam correspondence information may be based on a deterministic mapping of steered beam directions between a first set of beams for the first frequency band and a second set of beams for the second frequency band, as discussed with respect to FIG. 7C and/or 7D. This deterministic mapping may be applicable when the coverage (e.g., beamwidth) of one or more beams associated with the first frequency band overlaps with the coverage of one or more beams associated with the second frequency band, and where the boresight directions of the corresponding antenna elements in the first antenna arrays for the first frequency band and the second antenna arrays for the second frequency band are deterministically related. These relationships may be derived based on the spatial arrangement of the antenna panels where the first and second antenna arrays are located (e.g., the angle θ formed by the antenna panels).

At 906, the UE may receive from the base station a configuration for measurement of one or more beam measurements using the first frequency band. For example, the UE may receive one or more configurations from the base station for measuring one or more beams using the first frequency band. Based on these configurations, the UE may identify one or more beams associated with the first frequency band for communicating with the base station, based on the one or more beam measurements in the first frequency band.

FIG. 9B is a flowchart 950 of a method of wireless communication. The method may be performed by a UE (e.g., the UE 104; the UE 350 in FIG. 3; the UE 404 in FIG. 4; the UE 604 in FIG. 6; the UE 804 in FIG. 8; and/or the apparatus 1104 in the hardware implementation of FIG. 11). The method improves the efficient use of wireless resources and/or reduces power consumption at the UE by enabling measurement-less beam management based on cross-frequency or cross-analog beamforming relationships. Aspects enables additional frequency capability while saving time, power, and signaling measurements for beam management in the additional frequency range. Some aspects of FIG. 9B may be similar to the aspects of FIG. 9A and are shown with the same reference number.

At 902, the UE may transmit to a base station beam correspondence information between a first set of beams and a second set of beams, wherein the first set of beams includes one or more beams associated with a first frequency band and the second set of beams includes one or more beams associated with a second frequency band. In some aspects, this beam correspondence information may indicate a cross-frequency QCL relationship between the first set of one or more beams and the second set of one or more beams. As noted above, the beam correspondence information may be based on a one-to-one mapping between a first set of beam indices for the first frequency band and a second set of beam indices for the second frequency band, as discussed with respect to FIG. 7A and/or 7C. This one-to-one mapping may be applied when the number of antenna elements for the first frequency band in the first antenna array and the number of antenna elements for the second frequency band in the second antenna array are the same.

Additionally, or alternatively, the beam correspondence information may be based on a one-to-multiple beam mapping between a first set of beam indices for the first frequency band and a second set of beam indices for the second frequency band, as discussed with respect to FIG. 7B and/or 7D. This one-to-multiple mapping may be applied when the number of antenna elements for the first frequency band in the first antenna array differs from the number of antenna elements for the second frequency band in the second antenna array.

Additionally, or alternatively, the beam correspondence information may be based on a deterministic mapping of steered beam directions between a first set of beams for the first frequency band and a second set of beams for the second frequency band, as discussed with respect to FIG. 7C and/or 7D. This deterministic mapping may be applicable when the coverage (e.g., beamwidth) of one or more beams associated with the first frequency band overlaps with the coverage of one or more beams associated with the second frequency band, and where the boresight directions of the corresponding antenna elements in the first antenna arrays for the first frequency band and the second antenna arrays for the second frequency band are deterministically related. These relationships may be derived based on the spatial arrangement of the antenna panels where the first and second antenna arrays are located (e.g., the angle θ formed by the antenna panels).

At 906, the UE may receive from the base station a configuration for measurement of one or more beams using the first frequency band. For example, the UE may receive one or more configurations from the base station for measuring one or more beams using the first frequency band. Based on these configurations, the UE may identify one or more beams associated with the first frequency band for communicating with the base station, based on the one or more beam measurements in the first frequency band.

In some aspects, at 904, the UE may transmit an indication of support for a capability associated with measurement-less beam correspondence across the first frequency band and the second frequency band. In some aspects, the capability may include independent beam management for the first frequency band and the second frequency band.

In some aspects, the indication of support for a capability associated with measurement-less beam correspondence across the first frequency band and the second frequency band at 904 and beam correspondence information for a first set of one or more beams associated with the first frequency band and the second set of one or more beams associated with the second frequency band at 902 may also be communicated based on the identified one or more beams associated with the first frequency band.

In some aspects, at 908A and 910A, the UE may receive a RRC configuration indicating one or more of a first CC or a first beam group ID corresponding to a first analog beam group and a second CC or a second beam group ID corresponding to a second analog beam group and receive control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

Additionally, or alternatively, at 908B and 910B, the UE may receive a RRC configuration indicating a first set of TCI states for a first analog beam group associated with the first frequency band and a second set of TCI states for a second analog beam group associated with the second frequency band and receive a MAC-CE indicating a mapping between one or more TCI states of the first set of TCI states for the first frequency band and one or more TCI states of the second set of TCI states for the second frequency band.

In some aspects, at 912, the UE may communicate with the base station using a second beam for the second frequency band based on a measurement-less association with the first beam associated with the first frequency band. The measurement-less association may include the cross-frequency QCL relationship between the first set of one or more beams and the second set of one or more beams. For example, the UE may identify and use the appropriate beam(s) in the second frequency band without the need for direct measurement of those beams, relying on the measurement-less association and configuration provided by the base station. In some aspects, the appropriate beam(s) in the second frequency band may be identified based on one or more of the following criteria: a difference between the first direction of a first beam pattern peak of the first beam associated with the first frequency band and a second direction of a second beam pattern peak of the second beam associated with the second frequency band, an overlap between the first beamwidth of the first beam associated with the first frequency band and the second beamwidth of the second beam associated with the second frequency band, a defined correlation between the first beam and the second beam, a common quasi co-location (QCL) source shared by the first beam and the second beam, a reference signal received power (RSRP) difference between the first beam and the second beam, or an equivalent isotropic radiated power (EIRP) difference between the first beam and the second beam.

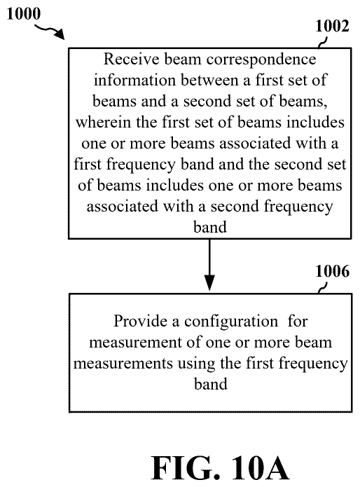

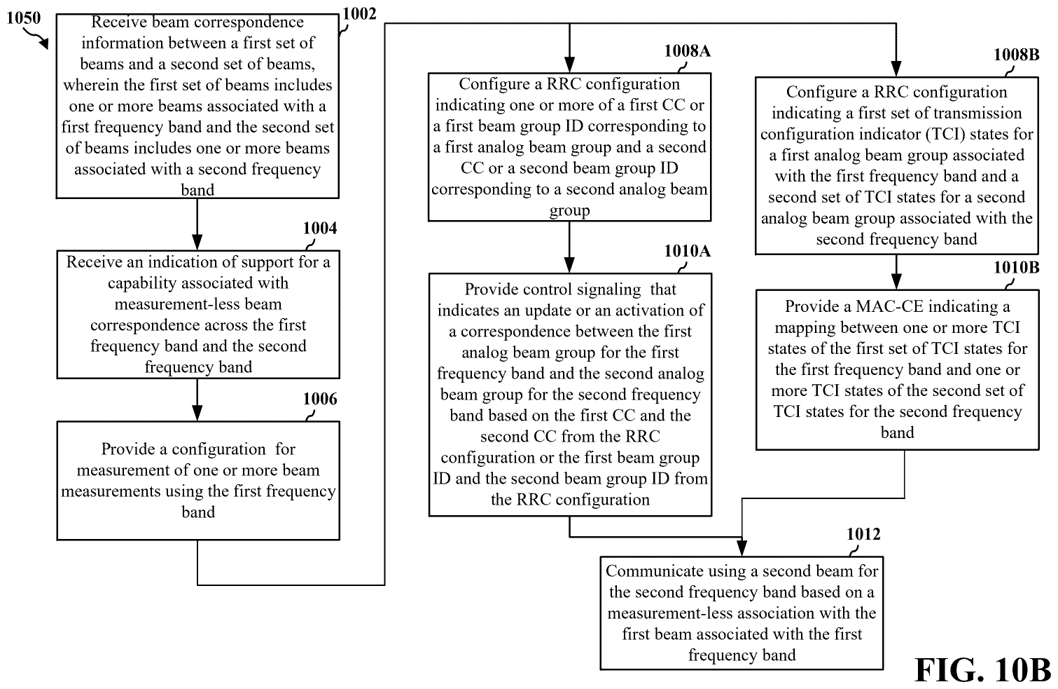

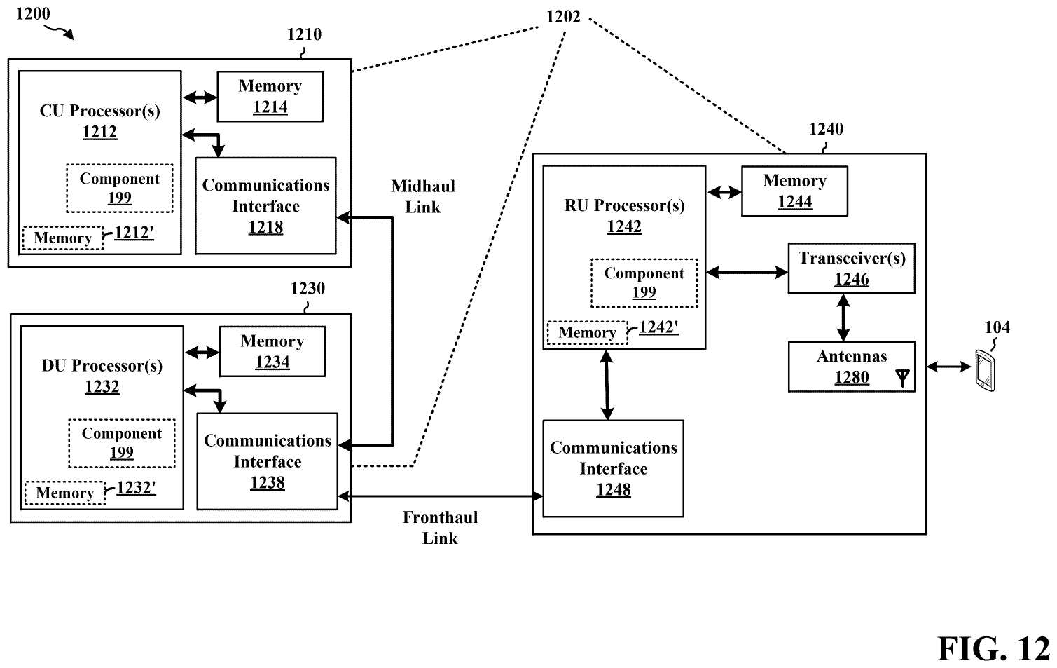

FIG. 10A is a flowchart 1000 of a method of wireless communication. The method may be performed by a base station (e.g., the base station 102 in aggregation and/or by one or more components (e.g., such as a CU 110, a DU 130, and/or an RU 140) in FIG. 1; the base station 310 in aggregation and/or by one or more components in FIG. 3; the base station 602 in FIG. 6; the base station 802 in FIG. 8; and/or the network entity 1202 in the hardware implementation of FIG. 12). The method improves the efficient use of wireless resources and/or reduces power consumption at the UE by enabling measurement-less beam management based on cross-frequency or cross-analog beamforming relationships. Aspects enables additional frequency capability while saving time, power, and signaling measurements for beam management in the additional frequency range.

At 1002, the base station may receive, from a UE, beam correspondence information between a first set of beams and a second set of beams, wherein the first set of beams includes one or more beams associated with a first frequency band and the second set of beams includes one or more beams associated with a second frequency band. In some aspects, this beam correspondence information may include a QCL relationship between beams associated with the first frequency band. As noted above, the beam correspondence information may be based on a one-to-one mapping between a first set of beam indices for the first frequency band and a second set of beam indices for the second frequency band, as discussed with respect to FIG. 7A and/or 7C. This one-to-one mapping may be applied when the number of antenna elements for the first frequency band in the first antenna array and the number of antenna elements for the second frequency band in the second antenna array are the same.

Additionally, or alternatively, the beam correspondence information may be based on a one-to-multiple beam mapping between a first set of beam indices for the first frequency band and a second set of beam indices for the second frequency band, as discussed with respect to FIG. 7B and/or 7D. This one-to-multiple mapping may be applied when the number of antenna elements for the first frequency band in the first antenna array differs from the number of antenna elements for the second frequency band in the second antenna array.

Additionally, or alternatively, the beam correspondence information may be based on a deterministic mapping of steered beam directions between a first set of beams for the first frequency band and a second set of beams for the second frequency band, as discussed with respect to FIG. 7C and/or 7D. This deterministic mapping may be applicable when the coverage (e.g., beamwidth) of one or more beams associated with the first frequency band overlaps with the coverage of one or more beams associated with the second frequency band, and where the boresight directions of the corresponding antenna elements in the first antenna arrays for the first frequency band and the second antenna arrays for the second frequency band are deterministically related. These relationships may be derived based on the spatial arrangement of the antenna panels where the first and second antenna arrays are located (e.g., the angle θ formed by the antenna panels).

At 1006, the base station may provide a configuration for measurement of one or more beam measurements using the first frequency band to the UE. For example, the base station may provide one or more configurations to the UE for measuring one or more beams using the first frequency band. Based on these configurations, the UE may identify one or more beams associated with the first frequency band for communicating with the base station, based on the one or more beam measurements in the first frequency band.

FIG. 10B is a flowchart 1050 of a method of wireless communication. The method may be performed by a base station (e.g., the base station 102 in aggregation and/or by one or more components (e.g., such as a CU 110, a DU 130, and/or an RU 140) in FIG. 1; the base station 310 in aggregation and/or by one or more components in FIG. 3; the base station 602 in FIG. 6; the base station 802 in FIG. 8; and/or the network entity 1202 in the hardware implementation of FIG. 12). The method improves the efficient use of wireless resources and/or reduces power consumption at the UE by enabling measurement-less beam management based on cross-frequency or cross-analog beamforming relationships. Aspects enables additional frequency capability while saving time, power, and signaling measurements for beam management in the additional frequency range. Some aspects of the flowchart 1050 may be similar to the flowchart 1000 in FIG. 10A and have a same reference number.

At 1002, the base station may receive, from a UE, beam correspondence information between a first set of beams and a second set of beams, wherein the first set of beams includes one or more beams associated with a first frequency band and the second set of beams includes one or more beams associated with a second frequency band. In some aspects, this beam correspondence information may include a QCL relationship between beams associated with the first frequency band. As noted above, the beam correspondence information may be based on a one-to-one mapping between a first set of beam indices for the first frequency band and a second set of beam indices for the second frequency band, as discussed with respect to FIG. 7A and/or 7C. This one-to-one mapping may be applied when the number of antenna elements for the first frequency band in the first antenna array and the number of antenna elements for the second frequency band in the second antenna array are the same.

Additionally, or alternatively, the beam correspondence information may be based on a one-to-multiple beam mapping between a first set of beam indices for the first frequency band and a second set of beam indices for the second frequency band, as discussed with respect to FIG. 7B and/or 7D. This one-to-multiple mapping may be applied when the number of antenna elements for the first frequency band in the first antenna array differs from the number of antenna elements for the second frequency band in the second antenna array.

Additionally, or alternatively, the beam correspondence information may be based on a deterministic mapping of steered beam directions between a first set of beams for the first frequency band and a second set of beams for the second frequency band, as discussed with respect to FIG. 7C and/or 7D. This deterministic mapping may be applicable when the coverage (e.g., beamwidth) of one or more beams associated with the first frequency band overlaps with the coverage of one or more beams associated with the second frequency band, and where the boresight directions of the corresponding antenna elements in the first antenna arrays for the first frequency band and the second antenna arrays for the second frequency band are deterministically related. These relationships may be derived based on the spatial arrangement of the antenna panels where the first and second antenna arrays are located (e.g., the angle θ formed by the antenna panels).

At 1006, the base station may provide a configuration for measurement of one or more beam measurements using the first frequency band to the UE. For example, the base station may provide one or more configurations to the UE for measuring one or more beams using the first frequency band. Based on these configurations, the UE may identify one or more beams associated with the first frequency band for communicating with the base station, based on the one or more beam measurements in the first frequency band.

In some aspects, at 1004, the base station may receive an indication of support for a capability associated with measurement-less beam correspondence across the first frequency band and the second frequency band. In some aspects, the capability may include independent beam management for the first frequency band and the second frequency band.

In some aspects, the indication of support for a capability associated with measurement-less beam correspondence across the first frequency band and the second frequency band at 1004 and beam correspondence information for a first set of one or more beams associated with the first frequency band and the second set of one or more beams associated with the second frequency band at 1002 may also be communicated based on the identified one or more beams associated with the first frequency band.

In some aspects, at 1008A and 1010A, the base station may configure a RRC configuration indicating one or more of a first CC or a first beam group ID corresponding to a first analog beam group and a second CC or a second beam group ID corresponding to a second analog beam group and provide control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

Additionally, or alternatively, at 1008B and 1010B, the base station may configure a RRC configuration indicating a first set of transmission configuration indicator (TCI) states for a first analog beam group associated with the first frequency band and a second set of TCI states for a second analog beam group associated with the second frequency band and receive a MAC-CE indicating a mapping between one or more TCI states of the first set of TCI states for the first frequency band and one or more TCI states of the second set of TCI states for the second frequency band.

In some aspects, at 1012, the base station may communicate with the UE using a second beam for the second frequency band based on a measurement-less association with the first beam associated with the first frequency band. The measurement-less association may indicate a cross-frequency QCL relationship between the first set of one or more beams and the second set of one or more beams. For example, the UE may identify and use the appropriate beam(s) in the second frequency band without the need for direct measurement of those beams, relying on the measurement-less association and configuration provided by the base station. In some aspects, the appropriate beam(s) in the second frequency band may be identified based on one or more of the following criteria: a difference between the first direction of a first beam pattern peak of the first beam associated with the first frequency band and a second direction of a second beam pattern peak of the second beam associated with the second frequency band, an overlap between the first beamwidth of the first beam associated with the first frequency band and the second beamwidth of the second beam associated with the second frequency band, a defined correlation between the first beam and the second beam, a common quasi co-location (QCL) source shared by the first beam and the second beam, a reference signal received power (RSRP) difference between the first beam and the second beam, or an equivalent isotropic radiated power (EIRP) difference between the first beam and the second beam.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor(s) 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor(s) 1124 communicates through the transceiver(s) 1122 via one or more antennas 1180 with the UE 104 and/or with an RU associated with a network entity 1102. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor(s) 1106 to perform the various functions described supra. The cellular baseband processor(s) 1124 and the application processor(s) 1106 are configured to perform the various functions described supra based at least in part of the information stored in the memory. That is, the cellular baseband processor(s) 1124 and the application processor(s) 1106 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1124/application processor(s) 1106 when executing software. The cellular baseband processor(s) 1124/application processor(s) 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the component 198 may be configured to transmit beam correspondence information for a first set of one or more beams associated with a first frequency band and a second set of one or more beams associated with a second frequency band; receive a configuration for measurement of one or more beam measurements using the first frequency band; transmitting an indication of support for a capability associated with measurement-less beam correspondence across the first frequency band and the second frequency band. The component 198, and/or the apparatus 1104, may be further configured to perform any of the aspects described in connection with the flowchart in FIG. 9A or 9B, the aspects performed by the UE in any of FIG. 1, 3, 4, 6, or 8. The component 198 may be within the cellular baseband processor(s) 1124, the application processor(s) 1106, or both the cellular baseband processor(s) 1124 and the application processor(s) 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor(s) 1124 and/or the application processor(s) 1106, may include means for transmitting beam correspondence information for a first set of one or more beams associated with a first frequency band and a second set of one or more beams associated with a second frequency band; receiving a configuration for measurement of one or more beam measurements using the first frequency band; transmitting an indication of support for a capability associated with measurement-less beam correspondence across the first frequency band and the second frequency band; receiving a RRC configuration indicating one or more of a first component carrier (CC) or a first beam group identifier (ID) corresponding to a first analog beam group and a second CC or a second beam group ID corresponding to a second analog beam group; receiving control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration; receiving a RRC configuration indicating a first set of transmission configuration indicator (TCI) states for a first analog beam group associated with the first frequency band and a second set of TCI states for a second analog beam group associated with the second frequency band; receiving a medium access control-control element (MAC-CE) indicating a mapping between one or more TCI states of the first set of TCI states for the first frequency band and one or more TCI states of the second set of TCI states for the second frequency band; identifying a first beam associated with the first frequency band based on the one or more beam measurements in the first frequency band; and communicating using a second beam for the second frequency band based on a measurement-less association with the first beam associated with the first frequency band. The apparatus may further include means for performing any of the aspects described in connection with the flowchart in FIG. 9A or 9B, the aspects performed by the UE in any of FIG. 1, 3, 4, 6, or 8. The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor(s) 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor(s) 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor(s) 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive beam correspondence information for a first set of one or more beams associated with a first frequency band and a second set of one or more beams associated with a second frequency band; and provide a configuration for measurement of one or more beam measurements using the first frequency band. The component 199 and/or the network entity may be configured to perform any of the aspects described in connection with the flowchart in FIG. 10A or 10B, the aspects performed by the base station in any of FIG. 1, 3, 4, 6, or 8. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 may include means for receiving beam correspondence information for a first set of one or more beams associated with a first frequency band and a second set of one or more beams associated with a second frequency band; providing a configuration for measurement of one or more beam measurements using the first frequency band; receiving an indication of support for a capability associated with measurement-less beam correspondence across the first frequency band and the second frequency band; configuring a RRC configuration indicating one or more of a first CC or a first beam group ID corresponding to a first analog beam group for the first frequency band and a second CC or a second beam group ID corresponding to a second analog beam group for the second frequency band; providing control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration; configuring a radio resource control (RRC) configuration indicating a first set of transmission configuration indicator (TCI) states for a first analog beam group associated with the first frequency band and a second set of TCI states for a second analog beam group associated with the second frequency band; providing a medium access control-control element (MAC-CE) indicating a mapping between one or more TCI states of the first set of TCI states for the first frequency band and one or more TCI states of the second set of TCI states for the second frequency band. The network entity may further include means for performing any of the aspects described in connection with the flowchart in FIG. 10A or 10B, the aspects performed by the base station in any of FIG. 1, 3, 4, 6, or 8. The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, comprising transmitting beam correspondence information between a first set of beams and a second set of beams, wherein the first set of beams includes one or more beams associated with a first frequency band and the second set of beams includes one or more beams associated with a second frequency band; and receiving a configuration for measurement of one or more beam measurements using the first frequency band.

Aspect 2 is the method of aspect 1, wherein the beam correspondence information indicates a cross-frequency quasi co-location (QCL) relationship between the first set of beams and the second set of beams.

Aspect 3 is the method of any of aspects 1 and 2, further comprising: transmitting an indication of support for a capability associated with measurement-less beam correspondence across the first frequency band and the second frequency band.

Aspect 4 is the method of any of aspects 1 to 3, wherein the capability includes independent beam management for the first frequency band and the second frequency band.

Aspect 5 is the method of any of aspects 1 to 4, wherein the beam correspondence information is based on a one-to-one mapping between a first set of beam indices for the first frequency band and a second set of beam indices for the second frequency band.

Aspect 6 is the method of any of aspects 1 to 4, wherein the beam correspondence information is based on a one-to-multiple beam mapping between a first set of beam indices for the first frequency band and a second set of beam indices for the second frequency band.

Aspect 7 is the method of any of aspects 1 to 4, wherein the beam correspondence information is based on a deterministic mapping of steered beam directions between the first set of beams for the first frequency band and the second set of beams for the second frequency band.

Aspect 8 is the method of any of aspects 1 to 7, further comprising: receiving a radio resource control (RRC) configuration indicating one or more of a first component carrier (CC) or a first beam group identifier (ID) corresponding to a first analog beam group and a second CC or a second beam group ID corresponding to a second analog beam group; and receiving, after transmission of the beam correspondence information, control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

Aspect 9 is the method of any of aspects 1 to 7, further comprising: receiving a RRC configuration indicating a first set of transmission configuration indicator (TCI) states for a first analog beam group associated with the first frequency band and a second set of TCI states for a second analog beam group associated with the second frequency band; and receiving a medium access control-control element (MAC-CE) indicating a mapping between one or more TCI states of the first set of TCI states for the first frequency band and one or more TCI states of the second set of TCI states for the second frequency band.

Aspect 10 is the method of any of aspects 1 to 9, further comprising: identifying a first beam associated with the first frequency band based on the one or more beam measurements in the first frequency band; and communicating using a second beam for the second frequency band based on a measurement-less association with the first beam associated with the first frequency band.

Aspect 11 is the method of any of aspects 1 to 10, wherein the second beam is selected based on one or more of: a difference between a first direction of a first beam pattern peak of the first beam associated with the first frequency band and a second direction of a second beam pattern peak of the second beam associated with the second frequency band, an overlap between a first beamwidth of the first beam associated with the first frequency band and a second beamwidth of the second beam associated with the second frequency band, a defined correlation between the first beam and the second beam, a common quasi co-location (QCL) source shared by the first beam and the second beam, a reference signal received power (RSRP) difference between the first beam and the second beam, or an equivalent isotropic radiated power (EIRP) difference between the first beam and the second beam.

Aspect 12 is an apparatus for wireless communication at a UE, comprising: at least one memory; and at least one processor coupled to the at least one memory, the at least one processor, individually or in any combination, is configured to perform the method of any of aspects 1 to 11.

Aspect 13 is a method of wireless communication at a network node, comprising receiving beam correspondence information between a first set of beams and a second set of beams, wherein the first set of beams includes one or more beams associated with a first frequency band and the second set of beams includes one or more beams associated with a second frequency band; and providing a configuration for measurement of one or more beam measurements using the first frequency band.

Aspect 14 is the method of aspect 13, wherein the beam correspondence information indicates a quasi co-location (QCL) relationship between beams associated with the first frequency band.

Aspect 15 is the method of any of aspects 13 and 14, further comprising: receiving an indication of support for a capability associated with measurement-less beam correspondence across the first frequency band and the second frequency band.

Aspect 16 is the method of any of aspects 13 to 15, wherein the capability includes independent beam management for the first frequency band and the second frequency band.

Aspect 17 is the method of any of aspects 13 to 16, wherein the beam correspondence information is based on a one-to-one mapping between beam a first set of beam indices for the first frequency band and a second set of beam indices for the second frequency band.

Aspect 18 is the method of any of aspects 13 to 16, wherein the beam correspondence information is based on a one-to-multiple beam mapping between a first set of beam indices for the first frequency band and a second set of beam indices for the second frequency band.

Aspect 19 is the method of any of aspects 13 to 16, wherein the beam correspondence information is based on a deterministic mapping of steered beam directions between the first set of beams for the first frequency band and the second set of beams for the second frequency band.

Aspect 20 is the method of any of aspects 13 to 19, further comprising: configuring a radio resource control (RRC) configuration indicating one or more of a first component carrier (CC) or a first beam group identifier (ID) corresponding to a first analog beam group and a second CC or a second beam group ID corresponding to a second analog beam group; and providing, after reception of the beam correspondence information, control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

Aspect 21 is the method of any of aspects 13 to 19, further comprising: configuring a radio resource control (RRC) configuration indicating a first set of transmission configuration indicator (TCI) states for a first analog beam group associated with the first frequency band and a second set of TCI states for a second analog beam group associated with the second frequency band; and providing a medium access control-control element (MAC-CE) indicating a mapping between one or more TCI states of the first set of TCI states for the first frequency band and one or more TCI states of the second set of TCI states for the second frequency band.

Aspect 22 is an apparatus for wireless communication at a network node, comprising means for performing each step in the method of any of aspects 13 to 21.

What is claimed is:

1. An apparatus for wireless communication at user equipment (UE), comprising:
at least one memory; and
at least one processor coupled to the at least one memory and, based at least in part on information stored in the at least one memory, the at least one processor, individually or in any combination, is configured to:
transmit beam correspondence information between a first set of beams and a second set of beams, wherein the first set of beams includes one or more beams associated with a first frequency band and the second set of beams includes one or more beams associated with a second frequency band; and
receive a configuration for measurement of one or more beam measurements using the first frequency band.

2. The apparatus of claim 1, wherein the beam correspondence information indicates a cross-frequency quasi co-location (QCL) relationship between the first set of beams and the second set of beams.

3. The apparatus of claim 1, wherein the at least one processor is further configured to:
transmit an indication of support for a capability associated with measurement-less beam correspondence across the first frequency band and the second frequency band.

4. The apparatus of claim 3, wherein the capability includes independent beam management for the first frequency band and the second frequency band.

5. The apparatus of claim 1, wherein the beam correspondence information is based on a one-to-one mapping between a first set of beam indices for the first frequency band and a second set of beam indices for the second frequency band.

6. The apparatus of claim 1, wherein the beam correspondence information is based on a one-to-multiple beam mapping between a first set of beam indices for the first frequency band and a second set of beam indices for the second frequency band.

7. The apparatus of claim 1, wherein the beam correspondence information is based on a deterministic mapping of steered beam directions between the first set of beams for the first frequency band and the second set of beams for the second frequency band.

8. The apparatus of claim 1, wherein the at least one processor is further configured to:
receive a radio resource control (RRC) configuration indicating one or more of a first component carrier (CC) or a first beam group identifier (ID) corresponding to a first analog beam group and a second CC or a second beam group ID corresponding to a second analog beam group; and
receive, after transmission of the beam correspondence information, control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

9. The apparatus of claim 1, wherein the at least one processor is further configured to:
receive a RRC configuration indicating a first set of transmission configuration indicator (TCI) states for a first analog beam group associated with the first frequency band and a second set of TCI states for a second analog beam group associated with the second frequency band; and
receive a medium access control-control element (MAC-CE) indicating a mapping between one or more TCI states of the first set of TCI states for the first frequency band and one or more TCI states of the second set of TCI states for the second frequency band.

10. The apparatus of claim 1, wherein the at least one processor is further configured to:
identify a first beam associated with the first frequency band based on the one or more beam measurements in the first frequency band; and
communicate using a second beam for the second frequency band based on a measurement-less association with the first beam associated with the first frequency band.

11. The apparatus of claim 10, wherein the second beam is selected based on one or more of:
a difference between a first direction of a first beam pattern peak of the first beam associated with the first frequency band and a second direction of a second beam pattern peak of the second beam associated with the second frequency band,
an overlap between a first beamwidth of the first beam associated with the first frequency band and a second beamwidth of the second beam associated with the second frequency band,
a defined correlation between the first beam and the second beam,
a common quasi co-location (QCL) source shared by the first beam and the second beam,
a reference signal received power (RSRP) difference between the first beam and the second beam, or
an equivalent isotropic radiated power (EIRP) difference between the first beam and the second beam.

12. An apparatus for wireless communication at a network node, comprising:
at least one memory; and
at least one processor coupled to the at least one memory and, based at least in part on information stored in the at least one memory, the at least one processor, individually or in any combination, is configured to:
receive beam correspondence information between a first set of beams and a second set of beams, wherein the first set of beams includes one or more beams associated with a first frequency band and the second set of beams includes one or more beams associated with a second frequency band; and
provide a configuration for measurement of one or more beam measurements using the first frequency band.

13. The apparatus of claim 12, wherein the beam correspondence information indicates a cross-frequency quasi co-location (QCL) relationship between the first set of beams and the second set of beams.

14. The apparatus of claim 12, wherein the at least one processor is further configured to:
receive an indication of support for a capability associated with measurement-less beam correspondence across the first frequency band and the second frequency band.

15. The apparatus of claim 14, wherein the capability includes independent beam management for the first frequency band and the second frequency band.

16. The apparatus of claim 12, wherein the beam correspondence information is based on a one-to-one mapping between a first set of beam indices for the first frequency band and a second set of beam indices for the second frequency band.

17. The apparatus of claim 12, wherein the beam correspondence information is based on a one-to-multiple beam mapping between a first set of beam indices for the first frequency band and a second set of beam indices for the second frequency band.

18. The apparatus of claim 12, wherein the beam correspondence information is based on mapping of steered beam directions between the first set of beams for the first frequency band and the second set of beams for the second frequency band.

19. The apparatus of claim 12, wherein the at least one processor is further configured to:
configure a radio resource control (RRC) configuration indicating one or more of a first component carrier (CC) or a first beam group identifier (ID) corresponding to a first analog beam group and a second CC or a second beam group ID corresponding to a second analog beam group; and
provide, after reception of the beam correspondence information, control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

20. The apparatus of claim 12, wherein the at least one processor is further configured to:
configure a radio resource control (RRC) configuration indicating a first set of transmission configuration indicator (TCI) states for a first analog beam group associated with the first frequency band and a second set of TCI states for a second analog beam group associated with the second frequency band; and
provide a medium access control-control element (MAC-CE) indicating a mapping between one or more TCI states of the first set of TCI states for the first frequency band and one or more TCI states of the second set of TCI states for the second frequency band.

21. A method of wireless communication at user equipment (UE), comprising:
transmitting beam correspondence information between a first set of beams and a second set of beams, wherein the first set of beams includes one or more beams associated with a first frequency band and the second set of beams includes one or more beams associated with a second frequency band; and
receiving a configuration for measurement of one or more beam measurements using the first frequency band.

22. The method of claim 21, wherein the beam correspondence information indicates a cross-frequency quasi co-location (QCL) relationship between the first set of beams and the second set of beams.

23. The method of claim 21, further comprising:
transmitting an indication of support for a capability associated with measurement-less beam correspondence across the first frequency band and the second frequency band.

24. The method of claim 23, wherein the capability includes independent beam management for the first frequency band and the second frequency band.

25. The method of claim 21, wherein the beam correspondence information is based on a one-to-one mapping between a first set of beam indices for the first frequency band and a second set of beam indices for the second frequency band.

26. The method of claim 21, wherein the beam correspondence information is based on a one-to-multiple beam mapping between a first set of beam indices for the first frequency band and a second set of beam indices for the second frequency band.

27. The method of claim 21, wherein the beam correspondence information is based on a deterministic mapping of steered beam directions between the first set of beams for the first frequency band and the second set of beams for the second frequency band.

28. The method of claim 21, further comprising:
receiving a radio resource control (RRC) configuration indicating one or more of a first component carrier (CC) or a first beam group identifier (ID) corresponding to a first analog beam group and a second CC or a second beam group ID corresponding to a second analog beam group; and
receiving, after transmission of the beam correspondence information, control signaling that indicates an update or an activation of a correspondence between the first analog beam group for the first frequency band and the second analog beam group for the second frequency band based on the first CC and the second CC from the RRC configuration or the first beam group ID and the second beam group ID from the RRC configuration.

29. The method of claim 21, further comprising:
receiving a RRC configuration indicating a first set of transmission configuration indicator (TCI) states for a first analog beam group associated with the first frequency band and a second set of TCI states for a second analog beam group associated with the second frequency band; and
receiving a medium access control-control element (MAC-CE) indicating a mapping between one or more TCI states of the first set of TCI states for the first frequency band and one or more TCI states of the second set of TCI states for the second frequency band.

30. A method of wireless communication at a network node, comprising:
receiving beam correspondence information between a first set of beams and a second set of beams, wherein the first set of beams includes one or more beams associated with a first frequency band and the second set of beams includes one or more beams associated with a second frequency band; and
providing a configuration for measurement of one or more beam measurements using the first frequency band.
